(19) United States
(12) Patent Application Publication
(10) Pub. No.: US 2023/0312209 A1
(43) Pub. Date: Oct. 5, 2023

(54) BLISTER PACKS AND USES THEREOF

(71) Applicant: 10x Genomics, Inc., Pleasanton, CA (US)

(72) Inventors: David MORGAN, San Leandro, CA (US); Evan DEJARNETTE, San Francisco, CA (US); Eric EVJE, Oakland, CA (US); Yiran ZHANG, Castro Valley, CA (US); Siyuan XING, Newark, CA (US)

(21) Appl. No.: 18/131,223

(22) Filed: Apr. 5, 2023

Related U.S. Application Data
(60) Provisional application No. 63/327,427, filed on Apr. 5, 2022.

(51) Int. Cl. B65D 75/36

(52) U.S. Cl. CPC B65D 75/36; B65D 2575/3218

(57) ABSTRACT

Systems that include blister packs and methods of use thereof are disclosed. In various embodiments, a system includes a blister pack having at least one blister comprising a base and a top layer. The blister contains a liquid reagent. The system further includes an actuator configured to release the liquid reagent from the blister. The system further includes a substrate configured to hold a tissue sample and receive the liquid reagent from the blister upon release.

### FIELD OF THE INVENTION

The present disclosure generally relates to blister packs containing reagents that can be used for analysis of samples (e.g., biological samples). In particular, the present disclosure relates to methods and systems that allow for precise dispensing of reagents to substrates containing a sample.

### BACKGROUND

Many biomedical applications rely on high-throughput assays of samples combined with one or more reagents using flow systems. For example, in both research and clinical applications, high throughput assays using target-specific reagents for analyzing molecules present in a biological sample can provide information for various applications. These applications may require a plurality of target-specific reagents to be applied to the biological sample. However, this often leads to cross contamination between the dispensed reagents and a reduction in the accuracy of the high-throughput assays. New methods that enable a fixed volume of target-specific reagents to be applied to a biological sample without cross contamination would be beneficial.

### BRIEF SUMMARY

In one aspect, the disclosure features a system having a blister pack that has a blister with a base and a top layer that houses a liquid reagent, an actuator that releases the liquid reagent from the blister, and a substrate that holds a tissue sample and receives the liquid reagent from the blister upon release. In some embodiments, the base of the blister is substantially flat. In some embodiments, the blister further includes an internal layer.

In some embodiments, the blister has a frangible seal, e.g., in the base or internal layer. In some embodiments, the blister pack includes a piercing member configured to pierce the internal layer. In some embodiments, the actuator is configured to apply a force to the piercing member.

In some embodiments, the actuator is configured to apply a force to the top layer of the blister. In some embodiments, the actuator includes a cylinder.

In some embodiments, the actuator is integral with the blister pack.

In some embodiments, the blister pack has a nozzle that dispenses the liquid reagent from the blister. In some embodiments, the nozzle is sealed. In some embodiments, the nozzle pierces the blister, e.g., the base or internal layer.

In some embodiments, the blister pack has a channel that transports the liquid reagent from the blister upon actuation.

In some embodiments, the blister pack has a plurality (e.g., 2, 3, 4, 5, 6, 7, 8, 9, 10, 20, 30, 40, 50, 60, 70, 80, 90, 100, 200, 300, 400, 500, or more) of blisters, each having a base and a top layer that houses a liquid reagent. In some embodiments, the plurality of blisters is linearly connected.

In some embodiments, the system has a reel on which the plurality of blisters is disposed. In some embodiments, the reel transports each blister adjacent the actuator. In some embodiments, the system has a second reel that receives the plurality of blisters following actuation.

In some embodiments, the blister and the substrate are integral. In some embodiments, the system has a layer disposed on the substrate to form a flow cell. In some embodiments, the flow cell has an inlet and an outlet. In some embodiments, the inlet is in fluid communication with the blister. In some embodiments, the outlet is in fluid communication with a reservoir.

In another aspect, the disclosure features a method for dispensing a reagent by providing a system as described herein. The method includes actuating the actuator to trigger release of the liquid reagent from the blister, and the reagent is dispensed to the substrate. In some embodiments, the base or internal layer of the blister includes a frangible seal, and the actuator breaks the frangible seal by compressing the blister.

In some of the embodiments, the blister pack includes a piercing member, and the actuator pushes the piercing member into the base or internal layer by compressing the blister.

In some embodiments, the system further includes a reel in which the plurality of blisters is disposed, and the method further includes transporting each blister adjacent the actuator.

In some embodiments, the system further includes a second reel that receives the plurality of blisters following actuation.

In some embodiments, each blister houses one of a plurality of distinct liquid reagents, and the dispensing step includes serially dispensing each distinct liquid reagent to the substrate.

### BRIEF DESCRIPTION OF THE DRAWINGS

FIG. 1A illustrates a blister pack, according to embodiments of the present disclosure. FIG. 1B illustrates a substrate having a biological sample positioned thereon, according to embodiments of the present disclosure.

FIG. 2 illustrates a cross-sectional side view of a blister pack, according to embodiments of the present disclosure.

FIG. 3 illustrates a cross-sectional side view of a blister pack, according to embodiments of the present disclosure.

FIG. 4 illustrates a partial cross-section of a blister pack, according to embodiments of the present disclosure.

FIG. 5A illustrates a cross-sectional side view of a blister pack with a nozzle sealed by a frangible seal, according to embodiments of the present disclosure. FIG. 5B illustrates a cross-sectional side view of the blister pack of FIG. 5A following breakage of the seal, according to embodiments of the present disclosure.

FIG. 6A illustrates a set of two reels an a linearly connected plurality of filled blisters wrapped around a first reel, according to embodiments of the present disclosure. FIG. 6B illustrates the first reel dispensing the filled blisters and the second reel receiving emptied blisters from the first reel. FIG. 6C illustrates the second reel having received the entire blister pack of emptied blisters.

FIGS. 7A-7B illustrate a system with a first reel having a linearly connected plurality of filled blisters and a second reel that receives linearly connected dispensed blisters, according to embodiments of the present disclosure.

FIG. 8 illustrates a blister pack having a plurality of blisters integrated with a substrate, according to embodiments of the present disclosure.

### DETAILED DESCRIPTION OF THE DISCLOSURE

The disclosure features systems that include blister packs and methods of use thereof. The systems and methods allow for a high throughput analysis to be performed using a blister pack containing one or more (e.g., a plurality of) blisters that contain a precise volume of one or more reagents. The systems and methods described herein reduce or eliminate cross-contamination during sample processing. Additionally, the systems and methods allow for dispensing a small quantity of a reagent from a blister with high accuracy. The systems and methods described herein may employ a reel containing a blister pack that includes a plurality of blisters for enhanced throughput.

### Definitions

To facilitate the understanding of this disclosure, a number of terms are defined below. Terms defined herein have meanings as commonly understood by a person of ordinary skill in the areas relevant to the disclosure. Terms such as “a”, “an,” and “the” are not intended to refer to only a singular entity, but include the general class of which a specific example may be used for illustration. The terminology herein is used to describe specific embodiments of the disclosure, but their usage does not limit the disclosure, except as outlined in the claims.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

As used herein, any values provided in a range of values include both the upper and lower bounds, and any values contained within the upper and lower bounds.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a mitochondrion, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) comprising a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or another organelle of a cell. A cell may be a live cell. The live cell may be capable of being cultured, for example, being cultured when enclosed in a gel or polymer matrix or cultured when comprising a gel or polymer matrix.

The term “fluidically connected,” as used herein, refers to a direct connection between at least two device elements, e.g., a channel, reservoir, etc., that allows for fluid to move between such device elements without passing through an intervening element.

The term “genome,” as used herein, generally refers to genomic information from a subject, which may be, for example, at least a portion or an entirety of a subject's hereditary information. A genome can be encoded either in DNA or in RNA. A genome can comprise coding regions that code for proteins as well as non-coding regions. A genome can include the sequence of all chromosomes together in an organism. For example, the human genome has a total of 46 chromosomes. The sequence of all of these together may constitute a human genome.

The term “in fluid communication with,” as used herein, refers to a connection between at least two device elements, e.g., a channel, reservoir, etc., that allows for fluid to move between such device elements with or without passing through one or more intervening device elements.

The term “particulate component of a cell” refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exosome, a liposome, an endoplasmic reticulum (e.g., rough or smooth), a ribosome, a Golgi apparatus, a chloroplast, an endocytic vesicle, an exocytic vesicle, a vacuole, a lysosome, or a mitochondrion.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. The sample may be a liquid sample, such as a blood sample, urine sample, or saliva sample. The sample may be a skin sample. The sample may be a cheek swap. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool, and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively, or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian, or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

Exemplary Systems

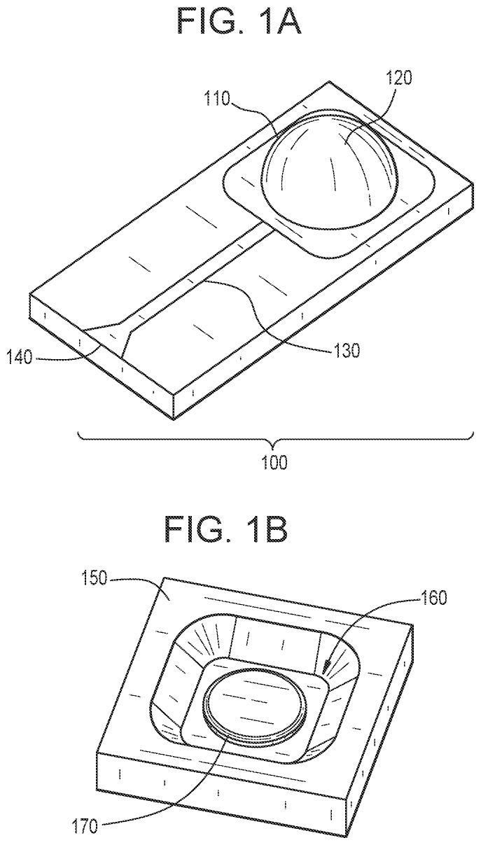

FIG. 1A illustrates a perspective view of an exemplary blister pack 100 containing a blister 110 filled with a reagent 120. The blister pack 100 contains a channel 130 that extends from the blister 110 to allow the reagent 120 to be dispensed from the blister 110. The channel contains an outlet 140 through which the reagent can exit the blister pack 100. FIG. 1B illustrates a perspective view of a substrate 150 containing a well 160 and a sample 170 (e.g., a biological sample) disposed in the well. The blister pack 100 may be arranged with the substrate 150 such that the reagent 120 is dispensed from the blister 110 through the outlet 140 of the channel 130 and into the well 160 of the substrate 150. The reagent 120 may then coat and/or immerse the sample 170 in the well 160.

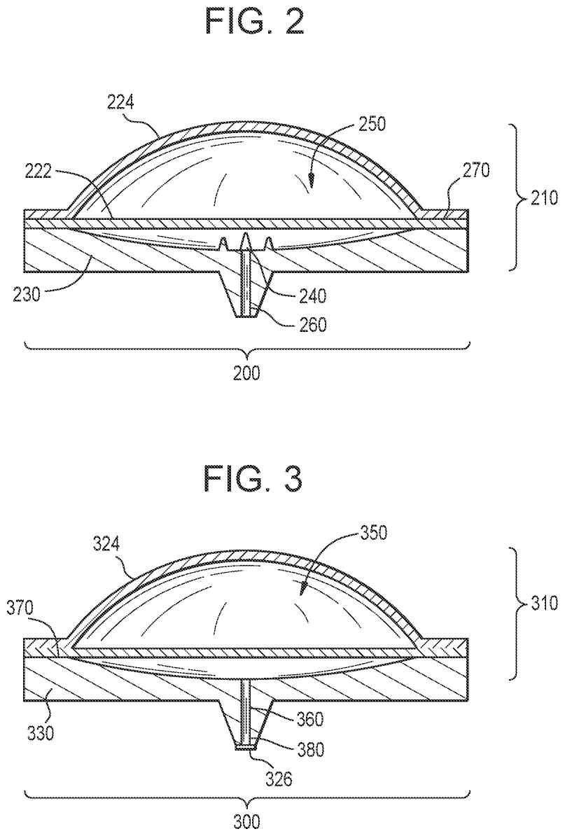

FIG. 2 illustrates a cross-sectional side view of an exemplary blister pack 200 with a blister 210. The blister pack 200 has a bottom foil laminate 222 inside the blister and a top foil laminate 224 that forms the reagent boundary of the blister with the bottom foil laminate 222. The top foil laminate 224 and bottom foil laminate 222 may be sealed with a seal 270 (e.g., heat seal). The base 230 of the blister 210 has one or more piercing members 240 configured to pierce the bottom foil laminate 222 and allow the reagent 250 to be dispensed from the blister 210 through a nozzle 260.

FIG. 3 illustrates a cross-sectional side view of an exemplary blister pack 300 with a blister 310. The blister pack 300 has a top foil laminate 324 that forms the reagent boundary of the blister with the base 330. The top foil laminate 324 and base 330 may be sealed with a seal 370 (e.g., heat seal). The base 330 of the blister 310 has a nozzle 360 and a foil laminate 326 sealing the outlet 380 of nozzle 360. Breaking the foil laminate 326 opens the outlet 380 of nozzle 360, allowing reagent 350 to be dispensed from the blister 310.

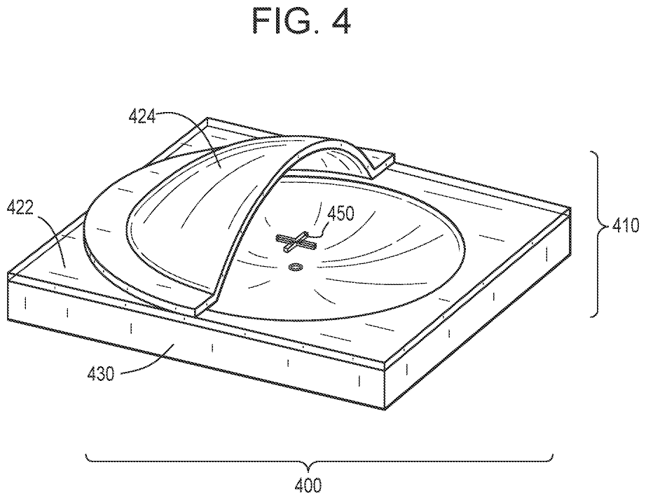

FIG. 4 illustrates a perspective view of an exemplary blister pack 400 with a blister 410 having a base 430 that has a bottom foil laminate 422 with a frangible seal 450 (e.g., a kiss cut part way through the bottom foil laminate) inside the blister 410. The top foil laminate 424 of the blister 410 may depress upon actuation, such that the frangible seal 450 breaks and dispenses the reagent 450 housed in the blister 410.

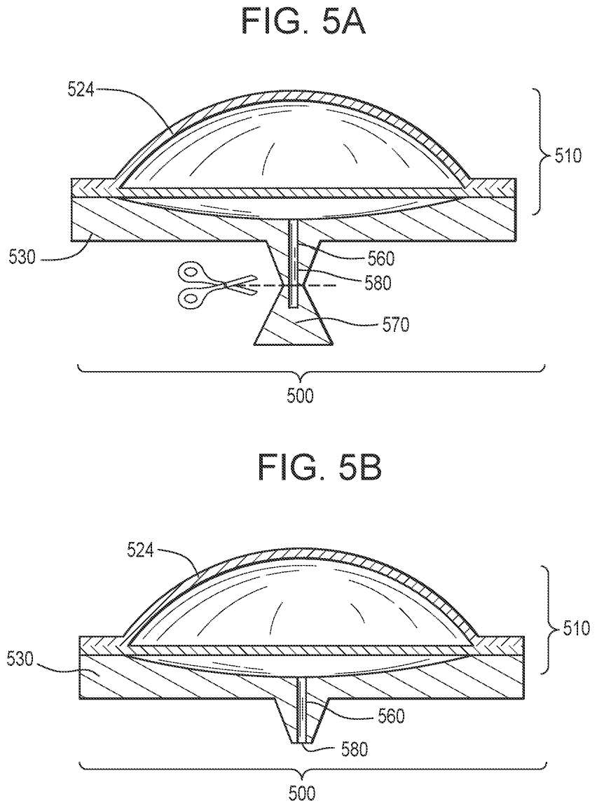

FIG. 5A illustrates a cross-sectional side view of an exemplary blister pack 500 with a blister 510 with a top foil laminate 524 sealed to base 530. The blister pack 500 has a base 530 and a nozzle 560 with a frangible seal 570 sealing the outlet 580 of nozzle 560. The seal 570 of the outlet 580 of the nozzle 560 can be broken (e.g., cut or torn) to open the outlet 580, thereby allowing the reagent 550 to be dispensed from blister 510. FIG. 5B illustrates a cross-sectional side view of the blister pack 500 in FIG. 5A with the frangible seal 570 removed, thereby opening the outlet 580 and allowing reagent to flow therefrom.

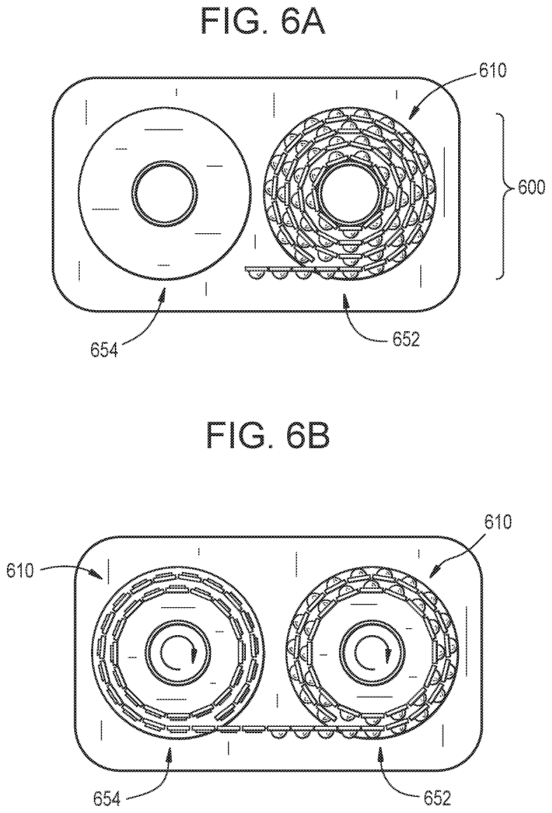

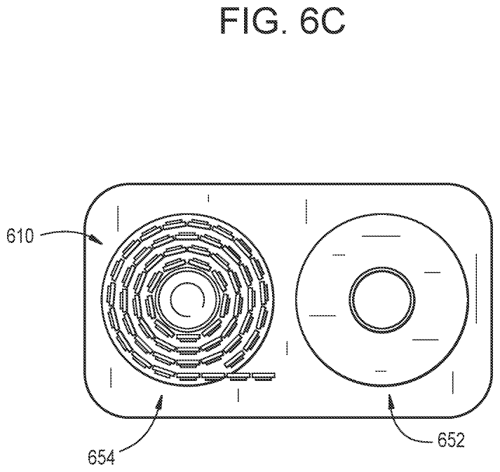

FIG. 6A illustrates a side view of an exemplary system with a blister pack 600 with a plurality of reagent-filled blisters 610. Each blister has a base and a top layer and contains a liquid reagent. In various embodiments, the plurality of reagent-filled blisters may include a same reagent (e.g., labelled oligonucleotide probes). In various embodiments, the plurality of reagent-filled blisters may include different reagents (e.g., labelled oligonucleotide probes). In various embodiments, the reagents contained within the linearly connected blisters correspond to cycled reagents for genomic analysis (e.g., in situ analysis). For example, the first fifteen blisters may be filled with reagents for each of fifteen cycles. In another example, the first 60 blisters may be filled with reagents for each of fifteen cycles such that four blisters are dispensed during each cycle. The plurality of blisters 610 is linearly connected and disposed on a first reel 652 that is configured to transport each blister 610 adjacent an actuator. The system further includes a second reel 654 configured to receive the plurality of blisters 610 following actuation to collect the emptied blisters 610 of the blister pack 600. FIG. 6B illustrates a side view of the system with blister pack 600 with a plurality of blisters 600. As the first reel 652 rotates, a dispensing mechanism causes the next reagent-filled blister 610 to break open and release its contents, and the second reel 654 gathers the emptied blisters 610. FIG. 6C illustrates a side view showing first reel 652 being empty and the second reel 654 containing the entire blister pack 600 of emptied blisters 610.

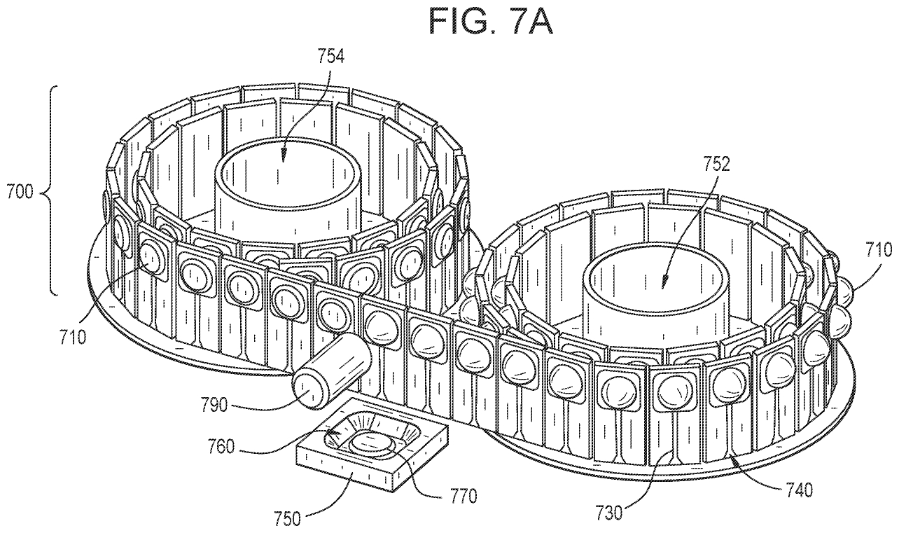

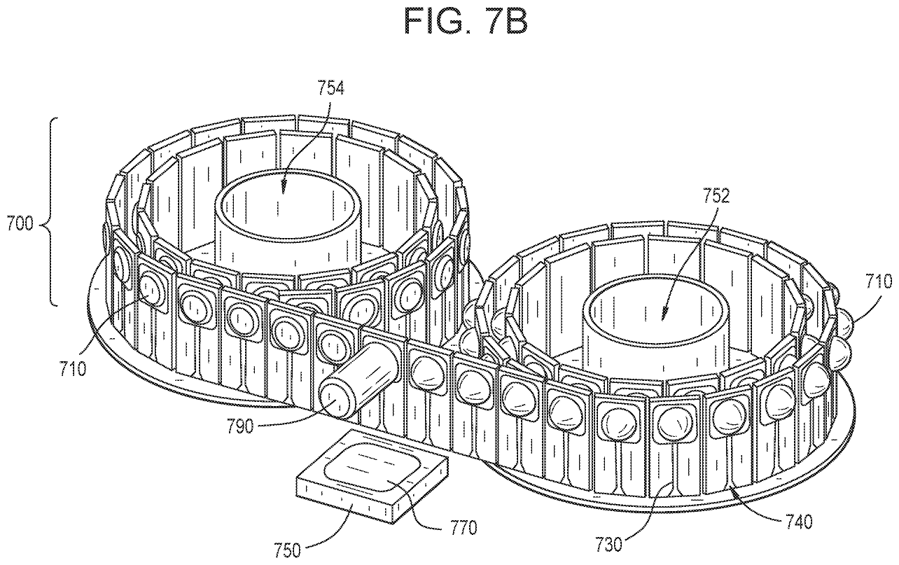

FIG. 7A illustrates a perspective view of an exemplary system with a blister pack 700 with a plurality of blisters 710. Each blister has a base and a top layer and houses a liquid reagent. The plurality of blisters 710 is linearly connected and disposed on a first reel 752 that is configured to transport each blister 710 adjacent an actuator 790. The system further includes a second reel 754 configured to receive the plurality of blisters 710 following actuation to collect the emptied blisters 710 of the blister pack 700. Each blister 710 is configured to dispense a reagent from the blister 710 through the outlet 740 of the channel 730 and into the well 760 of substrate 750 that contains a sample 770 (e.g., a biological sample). FIG. 7B illustrates a perspective view of the system with blister pack 700 with a plurality of blisters 710. The first reel 752 rotates and the actuator allows the blister 710 to release the reagent, while the second reel 754 gathers emptied blisters 710. Following actuation, the reagent from each blister 710 is dispensed from the blister 710, through the outlet 740 of the channel 730, and into the well 760 of substrate 750 that contains a sample 770 (e.g., a biological sample).

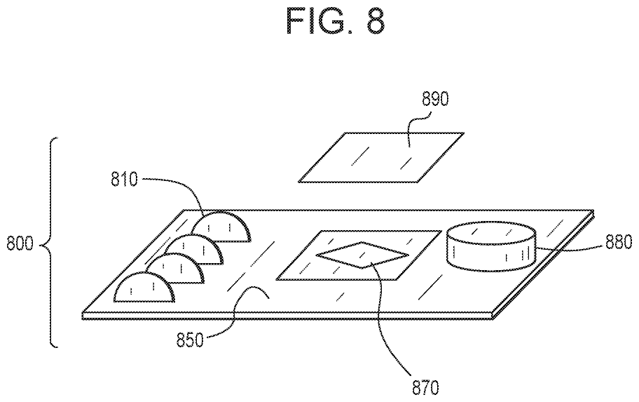

FIG. 8 illustrates a perspective view of a blister pack 800 having a plurality of blisters 810 integrated with a substrate 850. Each blister 810 contains a reagent that may be transported along a channel 830 to the substrate 850. A coverslip 890 may be disposed on the substrate 850 to form a flow cell containing sample chamber 870. The substrate 850 may further include a waste well 880 to receive reagents after the reagents have passed through the sample chamber 870 formed by substrate 850 and coverslip 890.

The systems described herein include a blister pack that stores one or more liquids within a blister. An actuator may be configured to compress a top layer of the blister pack such that the blister pack releases the liquid, e.g., via a nozzle, to a substrate.

The system can include a housing for all of the various components, e.g., the blister pack, blister, actuator, reel, substrate, or the like. The housing may also include a stage or a receptacle that houses the substrate. Systems may be used to deliver one or a series of liquid reagents to one or a series of substrates.

Blister Pack

The systems described herein include a blister pack having a blister that contains a liquid reagent (e.g., FIG. 1A). A blister has a base and a top layer enclosing a volume holding the liquid reagent. The base and top layer may be connected, e.g., with a heat seal, to contain the liquid reagent in the blister. In some embodiments, the base of the blister is substantially flat, e.g., smooth and/or even texture with no marked lumps or indentations. Alternatively, the base is not flat, e.g., round. The top of the blister may be, for example, rounded or dome shaped. The top layer is flexible to allow compression.

The blister may include an internal layer, e.g., a foil laminate layer. The top layer and internal layer may contain the liquid reagent in the blister. The internal layer may include a frangible seal that breaks upon compression of the top layer. Alternatively, the internal layer may distend into a piercing member to rupture, as described herein.

The base and/or top layer may be independently composed of any suitable material, for example, polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals (e.g. aluminum foil, tin foil, gold foil, etc.), ceramics, and combinations thereof.

The blister may house a volume of liquid reagent. For example, the blister may house a volume ranging from about 0.1 nL to about 5 mL, e.g., from about 0.1 nL to about 1 μL e.g., from about 0.1-1 nL, e.g., about 0.1 nL, 0.2 nL, 0.3 nL, 0.4 nL, 0.5 nL, 0.6 nL, 0.7 nL, 0.8 nL, 0.9 nL, or 1 nL, e.g., from about 1 nL to about 10 nL, e.g., about 1 nL, 2 nL, 3 nL, 4 nL, 5 nL, 6 nL, 7 nL, 8 nL, 9 nL, or 10 nL, e.g., from about 10 nL to about 100 nL, e.g., about 10 nL, 20 nL, 30 nL, 40 nL, 50 nL, 60 nL, 70 nL, 80 nL, 90 nL, or 100 nL, e.g., from about 100 nL to about 1 μL, e.g., about 100 nL, 200 nL, 300 nL, 400 nL, 500 nL, 600 nL, 700 nL, 800 nL, 900 nL, or 1 μL, e.g., from about 1 μL to about 10 μL, e.g., about 1 μL, 2 μL, 3 μL, 4 μL, 5 μL, 6 μL, 7 μL, 8 μL, 9 μL, or 10 μL, e.g., from about 10 μL to about 100 μL, e.g., about 10 μL, 20 μL, 30 μL, 40 μL, 50 μL, 60 μL, 70 μL, 80 μL, 90 μL, or 100 μL, e.g., from about 100 μL to about 1 mL, e.g., about 100 μL, 200 μL, 300 μL, 400 μL, 500 μL, 600 μL, 700 μL, 800 μL, 900 μL, or 1 mL, e.g., from about 1 mL to about 5 mL, e.g., about 1 mL, 2 mL, 3 mL, 4 mL, or 5 mL.

In some embodiments, the blister pack has a piercing member that pierces the blister (e.g., FIG. 2). The piercing member may pierce, for example, an internal layer in the blister. The piercing member may be a sharp object that may penetrate and/or rupture the internal layer of the blister. In some embodiments, the piercing member may include a point, such as but not limited to a point from a needle, or an edge from a blade, razor, scalpel, or similar object to cut, slice, puncture, or rupture. In some embodiments, the piercing member may have a bevel angle ranging from about 12° to about 60° (e.g., about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, about 35°, about 36°, about 37°, about 38°, about 39°, about 40°, about 41°, about 42°, about 43°, about 44°, about 45°, about 46°, about 47°, about 48°, about 49°, about 50°, about 51°, about 52°, about 53°, about 54°, about 55°, about 56°, about 57°, about 58°, about 59°, or about 60°).

The blister pack may have a nozzle that is configured to dispense the liquid reagent from the blister (e.g., FIG. 3). The nozzle is substantially hollow to permit the flow of the liquid reagent from the blister to the substrate. In some embodiments, the nozzle is sealed such that the liquid reagent is unable to escape the blister. In some embodiments, the nozzle may be sealed, e.g., with a foil seal. Seals include those that fail under pressure applied to the blister (e.g., FIG. 3). In some embodiments, the seal is cut and/or broken by an external mechanism (e.g., scissors, a razor, a blade, etc.) to allow the reagent to release from the blister (e.g., FIGS. 5A-5B). The system may include a component to open the seal, e.g., by cutting or breaking.

In other embodiments, the nozzle is not sealed, and the rupture or piercing of an internal layer allows liquid to pass through the nozzle. In some embodiments, the nozzle may include a needle, pin, or other piercing member, as described herein. In some embodiments, the nozzle may pierce an internal layer of the blister such that the liquid reagent may flow through the nozzle. The liquid reagent flowing through the nozzle may be dispensed to the substrate.

The nozzle may be or include a hollow needle. For example, the nozzle may have gauge, e.g., from 7 gauge to 34 gauge D (e.g., about 7 gauge, about 8 gauge, about 9 gauge, about 10 gauge, about 11 gauge, about 12 gauge, about 13 gauge, about 14 gauge, about 15 gauge, about 16 gauge, about 17 gauge, about 18 gauge, about 19 gauge, about 20 gauge, about 21 gauge, about 22 gauge, about 23 gauge, about 24 gauge, about 25 gauge, about 26 gauge, about 27 gauge, about 28 gauge, about 29 gauge, about 30 gauge, about 31 gauge, about 32 gauge, about 33 gauge, or about 34 gauge).

In some embodiments, the blister has a frangible seal. A frangible seal may break to allow the liquid reagent from the blister to be dispensed. The frangible seal may be on the base or the top layer or in an internal layer inside the blister. For example, the frangible seal may include partial cut such that, when the top layer of the blister is compressed, the frangible seal breaks under the pressure and releases the liquid reagent. In some embodiments, the frangible seal includes a kiss cut (e.g., FIG. 4).

In some embodiments, the blister pack has a channel configured to transport the liquid reagent from the blister upon actuation (e.g., FIG. 1A). The channel may have one or more cross sectional dimensions to transport the liquid reagent from the blister to a substrate. An exemplary range of maximum cross sectional dimension for voids for use as a channel is from 1 μm to 100 mm, e.g., from 1 μm to 10 μm, 10 μm to 20 μm, 20 μm to 30 μm, 30 μm to 40 μm, 40 μm to 50 μm, 50 μm to 60 μm, 60 μm to 70 μm, 70 μm to 80 μm, 80 μm to 90 μm, 90 μm to 100 μm, 1 mm to 3 mm, 1.5 mm to 3 mm, 2 mm to 3 mm, 120 μm to 2.5 mm, 150 μm to 2 mm, 150 μm to 1.5 mm, 250 μm to 1 mm, 400 μm to 1 mm, 1.5 mm to 5 mm, 1.5 mm to 4 mm, 2.5 mm to 3 mm, 2.5 mm to 5 mm, 3 mm to 5 mm, 4 mm to 5 mm, 4 mm to 6 mm, 3 mm to 7 mm, 5.5 mm to 8 mm, 6 mm to 10 mm, 6 mm to 9 mm, 8 mm to 10 mm, 9 mm to 10 mm, 10 mm to 20 mm, 15 mm to 45 mm, 20 mm to 50 mm, 30 mm to 50 mm, 35 mm to 65 mm, 10 mm to 60 mm, 60 mm to 100 mm, 70 mm to 90 mm, 55 mm to 85 mm, 40 mm to 70 mm, 75 mm to 100 mm, 80 mm to 90 mm, or 90 to 100 mm.

In some embodiments, the system includes a plurality of (e.g., 2, 3, 4, 5, 6, 6, 8, 9, 10, or more) blisters. In some embodiments, each blister of the plurality of blisters houses the same liquid reagent. In some embodiments, each blister may contain one of a plurality of different liquids, e.g., containing a specific reagent, e.g., for in situ-based methods (e.g., in situ hybridization or in situ sequencing), that is dispensed onto the sample. The blister pack may contain blisters ordered to provide a series of liquids to carry out a function e.g., washing, staining, fixation and postfixation, embedding, immunohistochemistry (IHC), isometric expansion, crosslinking and de-crosslinking, tissue permeabilization and treatment, analytes, endogenous analytes, labelling agents, sequencing, and the like as described herein.

Actuator

The systems described herein include an actuator that causes release of the liquid from the blister by compressing the top layer. In some embodiments, the actuator is a mechanical actuator. In some embodiments, the actuator employs hydraulic or pneumatic pressure. In some embodiments, the actuator includes a motor. The actuator may include a roller that compresses the top layer while the roller spins. The roller and/or blister pack may be moved relative to each other. Alternatively, the actuator may include an oscillating object to compress a stationary blister (e.g., FIGS. 7A-7B).

In some embodiments, the actuator includes any feature or component capable of applying a force, e.g., to the top layer of the blister. In some embodiments, the actuator includes a cylinder, a plate, or a plunger that contacts the blister, e.g., at the top layer of the blister. The actuator may contain a piercing member that pierces the blister. For example, the actuator may apply a force to the blister pack such that the piercing member pierces the blister, e.g., at an interior layer, and dispenses the liquid reagent. In some embodiments, the actuator compresses the blister, such that the piercing member pierces the blister, e.g., at an interior layer, and releases the liquid reagent.

The actuator causes release of the liquid reagent from the blister. In some embodiments, the actuator is configured to release the liquid reagent at a volumetric flow rate at any suitable rate. For example, the liquid may be released at a volumetric flow rate of from about 0.1 nL/s to about 1 μL/s, e.g., about 0.1-1 nL/s (e.g., about 0.1 nL/s, 0.2 nL/s, 0.3 nL/s, 0.4 nL/s, 0.5 nL/s, 0.6 nL/s, 0.7 nL/s, 0.8 nL/s, 0.9 nL/s, or 1 nL/s), e.g., about 1-10 nL/s (e.g., about 1 nL/s, 2 nL/s, 3 nL/s, 4 nL/s, 5 nL/s, 6 nL/s, 7 nL/s, 8 nL/s, 9 nL/s, or 10 nL/s), e.g., about 10-100 nL/s (e.g., about 10 nL/s, 20 nL/s, 30 nL/s, 40 nL/s, 50 nL/s, 60 nL/s, 70 nL/s, 80 nL/s, 90 nL/s, or 100 nL/s), or, e.g., about 100-1000 nL/s (e.g., about 100 nL/s, 200 nL/s, 300 nL/s, 400 nL/s, 500 nL/s, 600 nL/s, 700 nL/s, 800 nL/s, 900 nL/s, or 1000 nL/s).

Reel

The systems described herein may include a reel on which a plurality of blisters is disposed. The reel is configured to transport each blister adjacent the actuator. The reel may rotate, e.g., via a motor.

The plurality of blisters may be linearly connected and disposed on the reel (e.g., FIGS. 6A-6C). In some embodiments, the system includes a first reel that stores the blister pack and a second reel that receives the plurality of blisters following actuation (e.g., FIGS. 6A-6C).

The system may transport each blister from the first reel to the second reel such that each blister is transported adjacent to an actuator (e.g., FIG. 7A). The actuator may break the blister and cause the liquid reagent to be dispensed to a substrate (e.g., FIG. 7B). In some embodiments, the second reel receives each blister of the plurality of blisters following actuation.

Substrate

The systems described herein may include a substrate that holds a sample (e.g., a biological sample, such as a tissue sample) (e.g., FIG. 1B). In some embodiments, the thickness of the substrate is from about 1 μm to about 1 mm. In some embodiments, the thickness of the substrate is from about 1 μm to about 500 μm, from about 1 μm to about 250 μm, from about 10 μm to about 100 μm, from about 100 μm to about 500 μm, from about 100 μm to about 300 μm, from about 100 μm to about 200 μm, from about 120 μm to about 190 μm, or from about 150 μm to about 180 μm. In some embodiments, the thickness of the substrate Is from about 1 μm to about 10 μm, e.g., about 1 μm, 2 μm, 3 μm, 4 μm, 5 μm, 6 μm, 7 μm, 8 μm, 9 μm, or 10 μm, e.g., from about 10 μm to about 100 μm, e.g., about 10 μm, 20 μm, 30 μm, 40 μm, 50 μm, 60 μm, 70 μm, 80 μm, 90 μm, or 100 μm, e.g., from about 100 μm to about 1 mm, e.g., about 100 μm, 200 μm, 300 μm, 400 μm, 500 μm, 600 μm, 700 μm, 800 μm, 900 μm, or 1 mm. In some embodiments, the thickness of the substrate is about 0.17 mm.

The substrate may be any suitable shape, such as a square, rectangle, or circle, so long as to contain and/or visualize the sample. In some embodiments, the length and/or width of the substrate is, independently, from about 1 mm to about 10 cm, e.g., from about 1 mm to about 1 cm, e.g., about 2 mm, 3 mm, 4 mm, 5 mm, 6 mm, 7 mm, 8 mm, 9 mm, or 1 cm, e.g., from about 1 cm to about 10 cm, e.g., about 2 cm, 3 cm, 4 cm, 5 cm, 6 cm, 7 cm, 8 cm, 9 cm, or 10 cm. In some embodiments, the substrate is a coverslip, e.g., having dimensions of about 22 mm by 22 mm (square), about 24 mm by about 50 mm (rectangle), or a circle with diameter of about 12 mm or about 25 mm.

The substrate as described herein may be composed of polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like. The substrate may be fabricated in whole or in part from inorganic materials, such as silicon, or other silica-based materials, e.g., glass, quartz, fused silica, borosilicate glass, metals, ceramics, and combinations thereof.

In some embodiments, the blister pack and the substrate are integral. For example, a blister may be integrated on or adjacent the substrate (e.g., an injection molded chip) such that the actuator (e.g., a driver) may push the blister and release the reagent into a channel in the substrate (e.g., FIG. 8).

In some embodiments, the system further includes a layer, e.g., a coverslip including a sample, disposed on the substrate, e.g., to form a flow cell around the sample (e.g., biological sample or liquid reagent) (e.g., FIG. 8). The flow cell may contain an inlet and/or an outlet, e.g., to provide additional liquid reagents. The flow cell may be used in various downstream applications, such as detection, visualization, fixation, and the like.

In some embodiments, the substrate may also include a reservoir, e.g., for waste.

Surface Properties

A surface of the system may include a material, coating, or surface texture that determines the physical properties of the system. In particular, the flow of liquids may be controlled by the surface properties (e.g., wettability of a liquid-contacting surface). In some cases, a portion (e.g., a channel) may have a surface having a wettability suitable for facilitating liquid flow (e.g., in a channel).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method. The wettability of each surface may be suited to creating a hydrophobic boundary.

For example, portions of the system carrying aqueous phases (e.g., a channel or flow path) may have a surface material or coating that is hydrophilic or more hydrophilic than the other parts of the system, e.g., include a material or coating having a water contact angle of less than or equal to about 90°, and/or other components of the system may have a surface material or coating that is hydrophobic or more hydrophobic than another portion, e.g., include a material or coating having a water contact angle of greater than 70° (e.g., greater than 90°, greater than 95°, greater than 100° (e.g., 95°-120° or 100°-110°)). The system can be designed to have a single type of material or coating throughout. Surface textures may also be employed to control fluid flow.

The surface properties may be those of a native surface (i.e., the surface properties of the bulk material used for fabrication) or of a surface treatment. Non-limiting examples of surface treatments include, e.g., surface coatings and surface textures. In one approach, the surface properties are attributable to one or more surface coatings present in a portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the system. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be deposited on a surface by contacting it with trimethylaluminum (TMA) and water.

In another approach, the surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoroethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about 150°).

The difference in water contact angles between that of a hydrophilic or more hydrophilic material or coating and a hydrophobic or more hydrophobic material or coating may be 5° to 100°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 6°, 65°, 70°, 75°, 80°, 85°, 90°, 95°, or 100°.

Surfaces may also be coated with various functional materials, e.g., metals or other electrically or magnetically conducting materials. For example, a surface may include a metal coating for electrical connectivity, detection, or resistive heating. Alternatively, such elements may be physically incorporated into a system or placed in physical contact with a system.

Surface properties may also be modified after application. Such methods include exposure to UV, ozone, plasma (e.g., oxygen, argon, etc.), UV photografting and UV induced photo-catalytic oxidation. These and other methods can alter the properties of the surface (e.g., wettability such as hydrophilicity, fluorophilicity, or hydrophobicity) or add an additional layer (e.g., biomolecules) to the surface.

The above discussion centers on the water contact angle. It will be understood that liquids employed in the disclosure may not be water, or even aqueous. Accordingly, the actual contact angle of a liquid on a surface may differ from the water contact angle. Furthermore, the determination of a water contact angle of a material or coating can be made on that material or coating when not incorporated into the disclosure.

Reagents

The liquids described herein (e.g., in a blister) may contain one or more reagents that are delivered to a sample (e.g., a biological sample, such as a tissue sample). A liquid may include one or more (e.g., 2, 3, 4, 5, 6, 7, 8, 9, 10, or more) reagents, or each reagent may be contained in a distinct liquid. In embodiments in which in situ-based methods are performed, the reagents include, but are not limited to, probes, primers, nucleotide triphosphates (NTPs, e.g., dNTPs), sequencing terminators, dyes, replicating enzymes (e.g., DNA or RNA polymerases, reverse transcriptases, ligases), labels, and the like.

Other reagents that may be provided by a liquid include, without limitation, a tissue fixing agent, a tissue permeabilizer, such as a solvent (e.g., acetone and methanol) or a detergent (e.g., TRITON X-100, NP-40, TWEEN 20, saponin, digitonin, and LEUCOPERM).

In embodiments, the liquid reagent may include, for example, fixation and postfixation reagents, embedding reagents, staining and immunohistochemistry (IHC) reagents, isometric expansion reagents, crosslinking and de-crosslinking reagents, tissue permeabilization and treatment reagents, analytes, endogenous analytes, labelling agents, sequencing, and the like as described herein.

As described herein, a plurality of reagents may be loaded in a plurality of blisters that will be dispensed in sequence, e.g., on a sample in a substrate. The plurality may include the reagents necessary for a single assay or may include the reagents necessary for a plurality of assays to be performed, either on the same substrate or additional substrates that may be employed in the system.

Heating and Cooling

Systems of the disclosure may include a heater and/or cooler in thermal contact with a liquid, or in thermal contact with the sample. Suitable heaters for heating the liquids include, but are not limited to, thermoelectric heaters, e.g., thermistors, resistive foil, metal ceramic heaters, thermal tape, a Peltier stage, a TEC controller, etc. Exemplary coolers are high thermal mass or high surface area heat sinks, heat exchangers, Peltier stages, flowing water, a chiller pump, etc.

Heaters and coolers may be configured to supply fluid at appropriate temperatures to perform certain biochemical reactions, e.g., initialization, ligation, DNA melting, annealing, extension, denaturation, etc.

It will be understood that any of the heating sources and temperatures described herein may also be used together. For example, a Peltier stage may be used to heat a liquid, while a resistive foil or metal ceramic heater maintains the other parts of the system.

Kits

Systems of the disclosure may be combined with various external components, e.g., heaters, coolers, detectors, pumps, reservoirs, or controllers, one or more detectors (e.g., one or more lenses (e.g., tube lens), microscope objectives, lasers, spectrometers, etc.), liquid handlers, reagents (e.g., detectable labels, such as nucleic acids, oligonucleotides, ligands, enzymes, proteins, fluorochromes, metal ions, etc., e.g., analyte detection moieties, liquids, particles (e.g., beads), and/or sample) in the form of kits and systems.

Methods

In some embodiments, the method includes dispensing a reagent on a substrate. In some embodiments, the substrate has a biological sample disposed thereon, and the method includes dispensing a liquid reagent onto the sample. In some embodiments, the method includes dispensing a liquid reagent onto the substrate, e.g., to coat the substrate.

The liquid reagent may be dispensed at any suitable rate. For example, the liquid may be dispensed at a volumetric flow rate of from about 0.1 nL/s to about 1 μL/s, e.g., about 0.1-1 nL/s (e.g., about 0.1 nL/s, 0.2 nL/s, 0.3 nL/s, 0.4 nL/s, 0.5 nL/s, 0.6 nL/s, 0.7 nL/s, 0.8 nL/s, 0.9 nL/s, or 1 nL/s), e.g., about 1-10 nL/s (e.g., about 1 nL/s, 2 nL/s, 3 nL/s, 4 nL/s, 5 nL/s, 6 nL/s, 7 nL/s, 8 nL/s, 9 nL/s, or 10 nL/s), e.g., about 10-100 nL/s (e.g., about 10 nL/s, 20 nL/s, 30 nL/s, 40 nL/s, 50 nL/s, 60 nL/s, 70 nL/s, 80 nL/s, 90 nL/s, or 100 nL/s), or, e.g., about 100-1000 nL/s (e.g., about 100 nL/s, 200 nL/s, 300 nL/s, 400 nL/s, 500 nL/s, 600 nL/s, 700 nL/s, 800 nL/s, 900 nL/s, or 1000 nL/s).

While the liquid is in contact with, e.g., a tissue sample or other biological sample, reagents may diffuse from the liquid into the sample (e.g., tissue). The methods are advantageous for use in in situ-based methods, such as in situ hybridization and in situ sequencing.

The method includes providing a system as described herein that includes a blister pack and actuating the actuator. In some embodiments, actuating the actuator includes extending and/or retracting the actuator, e.g., adjacent a blister. The actuator may extend or retract along an axis perpendicular to the base of the blister. In some embodiments, the actuator may extend and/or retract having a speed range of from about 1 μm/s to about 100 mm/s e.g., about 1 μm/s-10 μm/s (e.g., about 1 μm/s, 2 μm/s, 3 μm/s, 4 μm/s, 5 μm/s, 6 μm/s, 7 μm/s, 8 μm/s, 9 μm/s, or 10 μm/s), e.g., about 10-100 μm/s (e.g., about 10 μm/s, 20 μm/s, 30 μm/s, 40 μm/s, 50 μm/s, 60 μm/s, 70 μm/s, 80 μm/s, 90 μm/s, or 100 μm/s), e.g., about 100 μm/s-1 mm/s (e.g., about 100 μm/s, 200 μm/s, 300 μm/s, 400 μm/s, 500 μm/s, 600 μm/s, 700 μm/s, 800 μm/s, 900 μm/s, or 1 mm/s), e.g., about 1 mm/s to about 10 mm/s (e.g., about 11 mm/s, 2 mm/s, 3 mm/s, 4 mm/s, 5 mm/s, 6 mm/s, 8 mm/s, 9 mm/s, or 10 mm/s), or, e.g., about 10 mm/s-100 mm/s (e.g., about 10 mm/s, 20 mm/s, 30 mm/s, 40 mm/s, 50 mm/s, 60 mm/s, 70 mm/s, 80 mm/s, 90 mm/s, or 100 mm/s). In some embodiments, the actuator actuates by extending and/or retracting a total distance of about 1 μm to about 10 cm e.g., about 1 μm to 10 μm (e.g., about 1 μm, 2 μm, 3 μm, 4 μm, 5 μm, 6 μm, 7 μm, 8 μm, 9 μm, or 10 μm), e.g., about 10 μm-100 μm (e.g., about 10 μm, 20 μm, 30 μm, 40 μm, 50 μm, 60 μm, 70 μm, 80 μm, 90 μm, or 100 μm), e.g., about 100 μm-1 mm (e.g., about 100 μm, 200 μm, 300 μm, 400 μm, 500 μm, 600 μm, 700 μm, 800 μm, 900 μm, or 1 mm), e.g., about 1 mm-1 cm (e.g., about 10 mm, 20 mm, 30 mm, 40 mm, 50 mm, 60 mm, 70 mm, 80 mm, 90 mm, or 1 cm), or e.g., about 1 mm-10 cm (e.g., about 1 mm, 2 mm, 3 mm, 4 mm, 5 mm, 6 mm, 7 mm, 8 mm, 9 mm, or 10 cm).

In some embodiments, actuating includes compressing the blister using a force exerted by the actuator. The compression of the blister using the force may break a frangible seal in the blister, e.g., in the base (e.g., sealing a nozzle) or in an internal layer. In some embodiments, actuating pierces the inside of the blister by pressing an internal layer into a piercing member in the base of. In some embodiments, actuation dispense liquids via a nozzle. The nozzle may be sealed by a seal requiring cutting or breaking separate from compression of the blister.

In some embodiments, the method employs a blister pack having a plurality of blisters, each having a base and a top layer and housing a liquid reagent. In some embodiments, each blister may contain one of a plurality of different liquids. In some embodiments, the method includes transporting a blister pack containing a plurality of blisters that are linearly connected and disposed on a reel. Other transport mechanisms for a series of blisters may also be employed. The method may include rotating the reel such that each blister moves adjacent an actuator (e.g., FIGS. 6A-6C). The rotation of the reel about the central axis may result in transporting the blister of a blister pack at a speed of about 0.1 revolutions/s to about 100 revolutions/s, e.g., about 0.1-1 revolutions/s (e.g., about 0.1 revolutions/s, 0.2 revolutions/s, 0.3 revolutions/s, 0.4 revolutions/s, 0.5 revolutions/s, 0.6 revolutions/s, 0.7 revolutions/s, 0.8 revolutions/s, 0.9 revolutions/s, or 1 revolutions/s), e.g., about 1-10 revolutions/s (e.g., about 1 revolutions/s, 2 revolutions/s, 3 revolutions/s, 4 revolutions/s, 5 revolutions/s, 6 revolutions/s, 7 revolutions/s, 8 revolutions/s, 9 revolutions/s, or 10 revolutions/s), or, e.g., about 10-100 revolutions/s (e.g., about 10 revolutions/s, 20 revolutions/s, 30 revolutions/s, 40 revolutions/s, 50 revolutions/s, 60 revolutions/s, 70 revolutions/s, 80 revolutions/s, 90 revolutions/s, or 100 revolutions/s). In some embodiments, transporting the blister of a blister pack includes positioning the blister adjacent the actuator, such that the actuator applies a force to the blister.

In some embodiments, the method employs a system that has a second reel that receives each blister of the plurality of blisters following actuation. In some embodiments, the second reel rotates at a speed similar to the first reel such that the second reel may receive each blister that has been transported by the first reel. The second reel may receive each blister of the plurality of blisters that have been emptied, and the liquid reagent has been substantially voided from the blister. In some embodiments, the blister contains less than 10% (e.g., less than 9%, 8%, 7%, 6%, 5%, 4%, 3%, 2%, 1%, or less) of the total volume of reagent following actuation.

In some embodiments, each blister houses one of a plurality of distinct liquid reagents, and the method includes serially dispensing each distinct liquid reagent to a single or multiple substrates.

Methods of Detection

In some embodiments, the methods described herein include detecting, e.g., tissue, cells, particulate components thereof, or other analytes. A sensor (e.g., optical, electrical, magnetic, impedance, or fluorescent sensor) in the detector may sense a particular feature (e.g., fluorescence, charge) or characteristic (e.g., diameter or volume) of sample (e.g., a cell or group of cells in a tissue sample). Methods of detection include optical detection, e.g., by visual observation, e.g., using an optical bright-field. In some embodiments, analytes thereof are detectable by light absorbance, scatter, emission, and/or transmission. Additionally, or alternatively, optical detection can include fluorescent detection, e.g., by fluorescent microscopy. In still further embodiments, methods of the disclosure include detection of analytes having electrical or magnetic labels or properties. In some embodiments, the system includes a plurality (e.g., 2, 3, 4, 5, 6, 7, 8, 9, 10, or more) of detectors. Detectors may or may not be integrated with the system. In some embodiments, the substrate layer and/or fluidic interface layer may be transparent, or include transparent portions, e.g., to allow for visualization, imaging, or detection. Substrate layers or fluidic interface layers, or portions thereof, may include transparent materials such as glass, quartz, polystyrene, polyethylene terephthalate, etc. The detection methods described herein may be automated, e.g., including robotic systems.

A variety of analytes, e.g., tissue, cell, or particulate component or macromolecular constituent thereof, characteristics can be observed and/or quantified. For example, characteristics such as analyte, e.g., cell, or particulate component or macromolecular constituent thereof, size (e.g., diameter) and shape can be readily observed visually and recorded by image or video acquisition software known in the art. In addition, the number of analytes, e.g., cell or particulate component thereof, can similarly be observed visually, by using detectable labels, or by other optical characteristics (e.g., scatter, absorbance, transmission, emission, such as fluorescence, etc.). In some embodiments, methods of the disclosure include observing the presence and/or intensity of a fluorescently or ionically tagged antigen-binding molecule bound to a biological antigen (e.g., a protein or nucleic acid, e.g., associated with an intact cell).

Preparation of Samples

A variety of steps can be performed to prepare a biological tissue sample for analysis. In some embodiments, a sample is collected or deposited in the system described here and prepared using a system described herein. In some embodiments, a prepared sample is placed on a substrate layer described herein. Except where indicated otherwise, the preparative steps described below can generally be combined in any manner to appropriately prepare a particular sample for analysis. In some aspects, any of the preparative or processing steps described can be performed on a sample using a system described herein, e.g., to deliver reagents via a fluid source. For example, the preparing or processing may include but is not limited to steps for fixing, embedding, staining, crosslinking, permeabilizing the sample, or any combinations thereof.

A biological tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 μm to about 20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is about 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the biological tissue sample (e.g., a tissue section as described above) can be prepared by deep freezing at a temperature suitable to maintain or preserve the integrity (e.g., the physical characteristics) of the tissue structure. Such a temperature can be, e.g., less than −20° C., or less than −25° C., −30° C., −40° C., −50° C., −60° C., −70° C., 80° C. −90° C., −100° C., −110° C., −120° C., −130° C., −140° C., −150° C., −160° C., −170° C., −180° C., −190° C., or −200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. A sample can be snap frozen in isopentane and liquid nitrogen. Frozen samples can be stored in a sealed container prior to embedding.

Fixation and Postfixation

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above.

Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some embodiments, the methods provided herein comprises one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex comprising a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can comprise a nucleic acid molecule (e.g., reporter oligonucleotide) comprising a sequence corresponding to the labelling agent and therefore corresponds to (e.g., uniquely identifies) the analyte. In some embodiments, the labelling agent can comprise a reporter oligonucleotide comprising one or more barcode sequences.

A post-fixing step may be performed using any suitable fixation reagent disclosed herein, for example, 3% (w/v) paraformaldehyde in DEPC-PBS.

Embedding

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material and activating the polymer material to form a hydrogel. In some embodiments, the hydrogel is formed such that the hydrogel is internalized within the biological sample.

In some embodiments, the biological sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to systems used to culture, maintain, or transport the cells. For example, hydrogel-matrices can be formed with monomer solution plus APS/TEMED added to the compartment to a depth ranging from about 0.1 μm to about 2 mm.

Additional methods and aspects of hydrogel embedding of biological samples are described for example in Chen et al., Science 347(6221):543-548, 2015, the entire contents of which are incorporated herein by reference.

Staining and Immunohistochemistry (IHC)

To facilitate visualization, biological samples can be stained using a wide variety of stains and staining techniques. In some embodiments, for example, a sample can be stained using any number of stains and/or immunohistochemical reagents. One or more staining steps may be performed to prepare or process a biological sample for an assay described herein or may be performed during and/or after an assay. In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g, DiI, DiO, DiR, DiD). Other cell membrane stains may include FM and RH dyes or immunohistochemical reagents specific for cell membrane proteins. In some examples, the stain may include but is not limited to, acridine orange (CAS #: 494-38-2), Bismarck brown (e.g., Bismark brown Y, CAS #: 8005-77-4), carmine, Coomassie blue (CAS #: 6104-59-2), cresyl violet (CAS #: 18472-89-4), 4′,6-diamidino-2-phenylindole (DAPI, CAS #: 28718-90-3)), eosin (e.g., eosin Y (CAS #: 17372-87-1) or eosin B (CAS #: 548-24-3)), ethidium bromide (CAS #: 1239-45-8), acid fuchsine (CAS #: 3244-88-0), haematoxylin (CAS #: 517-28-2), Hoechst stains, iodine (e.g., potassium triiodide), methyl green (CAS #: 82-94-0), methylene blue (CAS #: 61-73-4), neutral red (CAS #: 553-24-2), Nile blue (CAS #: 3625-57-8), Nile red (CAS #: 7385-67-3), osmium tetroxide, propidium iodide, rhodamine, or safranin (CAS #: 477-73-6)22rovide22i.

The sample can be stained using hematoxylin and eosin (H&E) staining techniques, using Papanicolaou staining techniques, Masson's trichrome staining techniques, silver staining techniques, Sudan staining techniques, and/or using Periodic Acid Schiff (PAS) staining techniques. PAS staining is typically performed after formalin or acetone fixation. In some embodiments, the sample can be stained using Romanowsky stain, including Wright's stain, Jenner's stain, Can-Grunwald stain, Leishman stain, and Giemsa stain.

In some embodiments, biological samples can be destained. Methods of destaining or discoloring a biological sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

Isometric Expansion

In some embodiments, a biological sample embedded in a matrix (e.g., a hydrogel) can be isometrically expanded. Isometric expansion methods that can be used include hydration, a preparative step in expansion microscopy, as described in Chen et al., Science 347(6221):543-548, 2015.

Isometric expansion can be performed by anchoring one or more components of a biological sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

In general, the steps used to perform isometric expansion of the biological sample can depend on the characteristics of the sample (e.g., thickness of tissue section, fixation, cross-linking), and/or the analyte of interest (e.g., different conditions to anchor RNA, DNA, and protein to a gel).

In some embodiments, proteins in the biological sample are anchored to a swellable gel such as a polyelectrolyte gel. An antibody can be directed to the protein before, after, or in conjunction with being anchored to the swellable gel. DNA and/or RNA in a biological sample can also be anchored to the swellable gel via a suitable linker. Examples of such linkers include, but are not limited to, 6-((Acryloyl)amino) hexanoic acid (Acryloyl-X SE) (available from ThermoFisher, Waltham, MA), Label-IT Amine (available from MirusBio, Madison, WI) and Label X (described for example in Chen et al., Nat. Methods 13:679-684, 2016, the entire contents of which are incorporated herein by reference).

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some embodiments, the sample is isometrically expanded to at least 2× and less than 20× of its non-expanded size.

Crosslinking and De-Crosslinking

In some embodiments, the biological sample is reversibly cross-linked prior to or during an in situ assay round. In some aspects, the analytes, polynucleotides and/or amplification product (e.g., amplicon) of an analyte or a probe bound thereto can be anchored to a polymer matrix. For example, the polymer matrix can be a hydrogel. In some embodiments, one or more of the polynucleotide probe(s) and/or amplification product (e.g., amplicon) thereof can be modified to contain functional groups that can be used as an anchoring site to attach the polynucleotide probes and/or amplification product to a polymer matrix. In some embodiments, a modified probe comprising oligo dT may be used to bind to mRNA molecules of interest, followed by reversible crosslinking of the mRNA molecules.

In some embodiments, the biological sample is immobilized in a hydrogel via cross-linking of the polymer material that forms the hydrogel. Cross-linking can be performed chemically and/or photochemically, or alternatively by any other hydrogel-formation method known in the art. A hydrogel may include a macromolecular polymer gel including a network. Within the network, some polymer chains can optionally be cross-linked, although cross-linking does not always occur.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GeIMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Patent Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after probes are provided to the sample. For example, hydrogel formation can be performed on the substrate already containing the probes.

In some embodiments, hydrogel formation occurs within a biological sample. In some embodiments, a biological sample (e.g., tissue section) is embedded in a hydrogel. In some embodiments, hydrogel subunits are infused into the biological sample, and polymerization of the hydrogel is initiated by an external or internal stimulus.

In embodiments in which a hydrogel is formed within a biological sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a biological sample is permanent. For example, biological macromolecules can permanently adhere to the hydrogel allowing multiple rounds of interrogation. In some embodiments, hydrogel formation within a biological sample is reversible.

In some embodiments, additional reagents are added to the hydrogel subunits before, contemporaneously with, and/or after polymerization. For example, additional reagents can include but are not limited to oligonucleotides (e.g., probes), endonucleases to fragment DNA, fragmentation buffer for DNA, DNA polymerase enzymes, dNTPs used to amplify the nucleic acid and to attach the barcode to the amplified fragments. Other enzymes can be used, including without limitation, RNA polymerase, transposase, ligase, proteinase K, and DNAse. Additional reagents can also include reverse transcriptase enzymes, including enzymes with terminal transferase activity, primers, and switch oligonucleotides. In some embodiments, optical labels are added to the hydrogel subunits before, contemporaneously with, and/or after polymerization.

In some embodiments, HTC reagents are added to the hydrogel before, contemporaneously with, and/or after polymerization. In some embodiments, a cell labelling agent is added to the hydrogel before, contemporaneously with, and/or after polymerization. In some embodiments, a cell-penetrating agent is added to the hydrogel before, contemporaneously with, and/or after polymerization.

Hydrogels embedded within biological samples can be cleared using any suitable method. For example, electrophoretic tissue clearing methods can be used to remove biological macromolecules from the hydrogel-embedded sample. In some embodiments, a hydrogel-embedded sample is stored before or after clearing of hydrogel, in a medium (e.g., a mounting medium, methylcellulose, or other semi-solid mediums).

In some embodiments, a method disclosed herein includes de-crosslinking the reversibly cross-linked biological sample. The de-crosslinking does not need to be complete. In some embodiments, only a portion of crosslinked molecules in the reversibly cross-linked biological sample are de-crosslinked and allowed to migrate.

Tissue Permeabilization and Treatment

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X-100™ or Tween-20™), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, dNase and rNase inactivating agents or inhibitors such as proteinase K, and/or chelating agents such as EDTA, can be added to the sample. For example, a method disclosed herein may comprise a step for increasing accessibility of a nucleic acid for binding, e.g., a denaturation step to opening up DNA in a cell for hybridization by a probe. For example, proteinase K treatment may be used to free up DNA with proteins bound thereto.

Analytes

The methods and systems disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of a rolling circle amplification (RCA) template (e.g., a padlock or other circularizable probe). Alternatively, the specific binding partner may be coupled to a nucleic acid, which may be detected using an RCA strategy, e.g., in an assay which uses or generates a circular nucleic acid molecule which can be the RCA template.

Analytes of particular interest may include nucleic acid molecules, such as DNA (e.g. genomic DNA, mitochondrial DNA, plastid DNA, viral DNA, etc.) and RNA (e.g. mRNA, microRNA, rRNA, snRNA, viral RNA, etc.), and synthetic and/or modified nucleic acid molecules, (e.g. including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which comprise a lipid or carbohydrate component. The analyte may be a single molecule or a complex that contains two or more molecular subunits, e.g. including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

Endogenous Analytes

In some embodiments, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that includes a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample, or can be obtained at intervals from a sample that continues to remain in viable condition.

Methods and systems disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte includes a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes comprise one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is comprised in the same analyte (e.g., nucleic acid) as the first single-stranded target sequence. Alternatively, the one or more second single-stranded target sequence is comprised in a different analyte (e.g., nucleic acid) from the first single-stranded target sequence.

Labelling Agents

In some embodiments, provided herein are methods and systems for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can comprise a reporter oligonucleotide that is indicative of the analyte or portion thereof interacting with the labelling agent. For example, the reporter oligonucleotide may comprise a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent includes an analyte binding moiety and a labelling agent barcode domain comprising one or more barcode sequences, e.g., a barcode sequence that corresponds to the analyte binding moiety and/or the analyte. An analyte binding moiety barcode includes to a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method includes one or more post-fixing (also referred to as post-fixation) steps after contacting the sample with one or more labelling agents.

In the methods and systems described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may comprise a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 2019/0177800; and U.S. Pat. Pub. 2019/0367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents comprising a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may comprise nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that includes a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer biding sequence (such as an R1, R2, or partial R1 or R2 sequence).

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

Products of Endogenous Analyte and/or Labelling Agent

In some embodiments, provided herein are methods and compositions for analyzing one or more products of an endogenous analyte and/or a labelling agent in a biological sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product, such as a rolling circle amplification (RCA) product) thereof is analyzed. In some aspects, the generation and/or processing of the analytes may be performed in the system and/or the analysis of the analytes may be performed in the system, such as by delivering reagents to a sample via a fluid source. For example, the generation, processing, and analysis may include but is not limited to reactions including hybridizations, ligations, binding, extension, amplifications, or other enzymatic reactions. In some embodiments, a labelling agent that directly or indirectly binds to an analyte in the biological sample is analyzed. In some embodiments, a product (e.g., a hybridization product, a ligation product, an extension product (e.g., by a DNA or RNA polymerase), a replication product, a transcription/reverse transcription product, and/or an amplification product, such as a rolling circle amplification (RCA) product), of a labelling agent that directly or indirectly binds to an analyte in the biological sample is analyzed.

Hybridization

In some embodiments, a product of an endogenous analyte and/or a labelling agent is a hybridization product comprising the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

Various probes and probe sets can be hybridized to an endogenous analyte and/or a labelling agent and each probe may comprise one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be comprised in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, provided herein is a probe or probe set capable of DNA-templated ligation, such as from a cDNA molecule. See, e.g., U.S. Pat. No. 8,551,710, which is hereby incorporated by reference in its entirety. In some embodiments, provided herein is a probe or probe set capable of RNA-templated ligation. See, e.g., U.S. Pat. Pub. 2020/0224244 which is hereby incorporated by reference in its entirety. In some embodiments, the probe set is a SNAIL probe set. See, e.g., U.S. Pat. Pub. 2019/0055594, which is hereby incorporated by reference in its entirety. In some embodiments, provided herein is a multiplexed proximity ligation assay. See, e.g., U.S. Pat. Pub. 2014/0194311 which is hereby incorporated by reference in its entirety. In some embodiments, provided herein is a probe or probe set capable of proximity ligation, for instance a proximity ligation assay for RNA (e.g., PLAYR) probe set. See, e.g., U.S. Pat. Pub. 2016/0108458, which is hereby incorporated by reference in its entirety. In some embodiments, a circular probe can be indirectly hybridized to the target nucleic acid. In some embodiments, the circular construct is formed from a probe set capable of proximity ligation, for instance a proximity ligation in situ hybridization (PLISH) probe set. See, e.g., U.S. Pat. Pub. 2020/0224243 which is hereby incorporated by reference in its entirety.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein includes an enzyme that is commonly used to join polynucleotides together or to join the ends of a single polynucleotide. An RNA ligase, a DNA ligase, or another variety of ligase can be used to ligate two nucleotide sequences together. Ligases comprise ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases comprise bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. ““Direct ligatio”” means that the ends of the polynucleotides hybridize immediately adjacently to one another to form a substrate for a ligase enzyme resulting in their ligation to each other (intramolecular ligation). Alternatively, ““indirec”” means that the ends of the polynucleotides hybridize non-adjacently to one another, i.e., separated by one or more intervening nucleotides or ““gap””. In some embodiments, said ends are not ligated directly to each other, but instead occurs either via the intermediacy of one or more intervening (so-called ““ga”” or ““gap-fillin”” (oligo)nucleotides) or by the extension of the “end of a probe to ““fil”” the ““ga”” corresponding to said intervening nucleotides (intermolecular ligation). In some cases, the gap of one or more nucleotides between the hybridized ends of the polynucleotides may be ““fille”” by one or more ““ga”” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9, or 10 or more nucleotides, of any integer (or range of integers) of nucleotides in between the indicated values. In some embodiments, the gap between said terminal regions may be filled by a gap oligonucleotide or by extending the “end of a polynucleotide. In some cases, ligation involves ligating the ends of the probe to at least one gap (oligo)nucleotide, such that the gap (oligo)nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, comprising amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperaturel) of the DNA strands. This selectively reduces the concentration of annealed mismatched substrates (expected to have a slightly lower Tₘ around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

Primer Extension and Amplification

In some embodiments, a product is a primer extension product of an analyte, a labelling agent, a probe, or probe set bound to the analyte (e.g., a padlock probe bound to genomic DNA, mRNA, or cDNA), or a probe or probe set bound to the labelling agent (e.g., a padlock probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA includes a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

This amplification step can utilize isothermal amplification or non-isothermal amplification. In some embodiments, after the formation of the hybridization complex and association of the amplification probe, the hybridization complex is rolling circle amplified to generate a cDNA nanoball (i.e., amplicon) containing multiple copies of the cDNA. Techniques for rolling circle amplification (RCA) are known in the art such as linear RCA, a branched RCA, a dendritic RCA, or any combination thereof. (See, e.g., Baner et al, Nucleic Acids Research, 26:5073-5078, 1998; Lizardi et al, Nature Genetics 19:226, 1998; Mohsen et al., Acc Chem Res. 2016 Nov. 15; 49(11): 2540-2550; Schweitzer et al. Proc. Natl Acad. Sci. USA 97:101 13-119, 2000; Faruqi et al, BMC Genomics 2:4, 2000; Nallur et al, Nucl. Acids Res. 29:e118, 2001; Dean et al. Genome Res. 11:1095-1099, 2001; Schweitzer et al, Nature Biotech. 20:359-365, 2002; U.S. Pat. Nos. 6,054,274, 6,291,187, 6,323,009, 6,344,329 and 6,368,801). Exemplary polymerases for use in RCA comprise DNA polymerase such phi29 (φ29) polymerase, Klenow fragment, Bacillus stearothermophilus DNA polymerase (BST), T4 DNA polymerase, T7 DNA polymerase, or DNA polymerase I. In some aspects, DNA polymerases that have been engineered or mutated to have desirable characteristics can be employed. In some embodiments, the polymerase is phi29 DNA polymerase.

In some aspects, during the amplification step, modified nucleotides can be added to the reaction to incorporate the modified nucleotides in the amplification product (e.g., nanoball). Exemplary of the modified nucleotides comprise amine-modified nucleotides. In some aspects of the methods, for example, for anchoring or cross-linking of the generated amplification product (e.g., nanoball) to a scaffold, to cellular structures and/or to other amplification products (e.g., other nanoballs). In some aspects, the amplification products comprises a modified nucleotide, such as an amine-modified nucleotide. In some embodiments, the amine-modified nucleotide comprises an acrylic acid N-hydroxysuccinimide moiety modification. Examples of other amine-modified nucleotides comprise, but are not limited to, a 5-Aminoallyl-dUTP moiety modification, a 5-Propargylamino-dCTP moiety modification, a N6-6-Aminohexyl-dATP moiety modification, or a 7-Deaza-7-Propargylamino-dATP moiety modification.

In some aspects, the polynucleotides and/or amplification product (e.g., amplicon) can be anchored to a polymer matrix. For example, the polymer matrix can be a hydrogel. In some embodiments, one or more of the polynucleotide probe(s) can be modified to contain functional groups that can be used as an anchoring site to attach the polynucleotide probes and/or amplification product to a polymer matrix. Exemplary modification and polymer matrix that can be employed in accordance with the provided embodiments comprise those described in, for example, WO 2014/163886, WO 2017/079406, US 2016/0024555, US 2018/0251833 and US 2017/0219465. In some examples, the scaffold also contains modifications or functional groups that can react with or incorporate the modifications or functional groups of the probe set or amplification product. In some examples, the scaffold can comprise oligonucleotides, polymers or chemical groups, to provide a matrix and/or support structures.

The amplification products may be immobilized within the matrix generally at the location of the nucleic acid being amplified, thereby creating a localized colony of amplicons. The amplification products may be immobilized within the matrix by steric factors. The amplification products may also be immobilized within the matrix by covalent or noncovalent bonding. In this manner, the amplification products may be considered to be attached to the matrix. By being immobilized to the matrix, such as by covalent bonding or cross-linking, the size and spatial relationship of the original amplicons is maintained. By being immobilized to the matrix, such as by covalent bonding or cross-linking, the amplification products are resistant to movement or unraveling under mechanical stress.

In some aspects, the amplification products are copolymerized and/or covalently attached to the surrounding matrix thereby preserving their spatial relationship and any information inherent thereto. For example, if the amplification products are those generated from DNA or RNA within a cell embedded in the matrix, the amplification products can also be functionalized to form covalent attachment to the matrix preserving their spatial information within the cell thereby providing a subcellular localization distribution pattern. In some embodiments, the provided methods involve embedding the one or more polynucleotide probe sets and/or the amplification products in the presence of hydrogel subunits to form one or more hydrogel-embedded amplification products. In some embodiments, the hydrogel-tissue chemistry described comprises covalently attaching nucleic acids to in situ synthesized hydrogel for tissue clearing, enzyme diffusion, and multiple-cycle sequencing while an existing hydrogel-tissue chemistry method cannot. In some embodiments, to enable amplification product embedding in the tissue-hydrogel setting, amine-modified nucleotides are comprised in the amplification step (e.g., RCA), functionalized with an acrylamide moiety using acrylic acid N-hydroxysuccinimide esters, and copolymerized with acrylamide monomers to form a hydrogel.

In some embodiments, the RCA template may comprise the target analyte, or a part thereof, where the target analyte is a nucleic acid, or it may be provided or generated as a proxy, or a marker, for the analyte. As noted above, many assays are known for the detection of numerous different analytes, which use a RCA-based detection system, e.g., where the signal is provided by generating a RCP from a circular RCA template which is provided or generated in the assay, and the RCP is detected to detect the analyte. The RCP may thus be regarded as a reporter which is detected to detect the target analyte. However, the RCA template may also be regarded as a reporter for the target analyte; the RCP is generated based on the RCA template and comprises complementary copies of the RCA template. The RCA template determines the signal, which is detected, and is thus indicative of the target analyte. As will be described in more detail below, the RCA template may be a probe, or a part or component of a probe, or may be generated from a probe, or it may be a component of a detection assay (i.e., a reagent in a detection assay), which is used as a reporter for the assay, or a part of a reporter, or signal-generation system. The RCA template used to generate the RCP may thus be a circular (e.g., circularized) reporter nucleic acid molecule, namely from any RCA-based detection assay which uses or generates a circular nucleic acid molecule as a reporter for the assay. Since the RCA template generates the RCP reporter, it may be viewed as part of the reporter system for the assay.

In some embodiments, a product herein includes a molecule or a complex generated in a series of reactions, e.g., hybridization, ligation, extension, replication, transcription/reverse transcription, and/or amplification (e.g., rolling circle amplification), in any suitable combination. For example, a product comprising a target sequence for a probe disclosed herein may be a hybridization complex formed of a cellular nucleic acid in a sample and an exogenously added nucleic acid probe. The exogenously added nucleic acid probe may comprise an overhang that does not hybridize to the cellular nucleic acid but hybridizes to another probe. The exogenously added nucleic acid probe may be optionally ligated to a cellular nucleic acid molecule or another exogenous nucleic acid molecule. In other examples, a product comprising a target sequence for a probe disclosed herein may be an RCP of a circularizable probe or probe set which hybridizes to a cellular nucleic acid molecule (e.g., genomic DNA or mRNA) or product thereof (e.g., a transcript such as cDNA, a DNA-templated ligation product of two probes, or an RNA-templated ligation product of two probes). In other examples, a product comprising a target sequence for a probe disclosed herein may a probe hybridizing to an RCP. The probe may comprise an overhang that does not hybridize to the RCP but hybridizes to another probe. The probe may be optionally ligated to a cellular nucleic acid molecule or another probe, e.g., an anchor probe that hybridize to the RCP.

Target Sequences

A target sequence for a probe disclosed herein may be comprised of any analyte disclosed herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode includes about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In any of the preceding embodiments, barcodes (e.g., primary and/or secondary barcode sequences) can be analyzed (e.g., detected or sequenced) using any suitable methods or techniques, including those described herein, such as RNA sequential probing of targets (RNA SPOTs), sequential fluorescent in situ hybridization (seqFISH), single-molecule fluorescent in situ hybridization (smFISH), multiplexed error-robust fluorescence in situ hybridization (MERFISH), in situ sequencing, hybridization-based in situ sequencing (HybISS), targeted in situ sequencing, fluorescent in situ sequencing (FISSEQ), sequencing by synthesis (SBS), sequencing by ligation (SBL), sequencing by hybridization (SBH), or spatially-resolved transcript amplicon readout mapping (STARmap). In any of the preceding embodiments, the methods provided herein can include analyzing the barcodes by sequential hybridization and detection with a plurality of labelled probes (e.g., detection oligos).

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence includes 4^{N} complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (4⁵=1024), whereas 8 nucleotide barcodes can be used to identify up to 65,536 molecular species, a number greater than the total number of distinct genes in the human genome. In some embodiments, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 2019/0055594 and WO2019199579A1, which are hereby incorporated by reference in their entirety.

Assays and In Situ Methods

The methods described herein may be useful for analysis methods in which specific reagents are added to a sample. In some embodiments, reagents are added to the sample in the system which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the system after performing steps of the assay described herein. In some embodiments, the system is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. The methods described herein may be useful for array-based methods in which specific reagents are contacted with a sample. In some embodiments, the surface of the fluidic interface layer or substrate layer may have an array of bound reagents. In some embodiments, a system is used to deliver reagents to the sample which is deposited on the array.

The in situ methods described herein may be used to detect and or quantify nucleic acids in a biological sample spatially by performing the method on the sample at one or more regions of interest. The in situ methods include using one or more fluid sources to flow in one or more reagents sequentially to contact the sample, e.g., at the region of interest, performing a hybridization and/or a chemical reaction with a labeled oligonucleotide, and detecting the label. Additional steps are described in more detail below.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a biological sample (e.g., tissue). The biological sample may be provided in the system, e.g., on a substrate layer. The sample may be permeabilized by adding a fluid, such as a solvent (e.g., acetone and methanol) or a detergent (e.g., TRITON X-100, NP-40, TWEEN 20, saponin, digitonin, and Leucoperm), to the sample. Permeabilization may allow or enhance access of the probes for the intracellular space of the sample.

A probe may then be added to the sample, e.g., by flowing a fluid containing the probe through the inlet, to contact the biological sample (e.g., the sample medium containing the biological sample), e.g., at the region of interest. The probe hybridizes to the target, e.g., an mRNA. Any unbound probes may be washed away by flowing another fluid lacking the probe through the sample, e.g., via the inlet. The fluid containing the unbound probes may be removed from the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, following signal amplification, the sample may be embedded, e.g., in a hydrogel.

In some embodiments, the signal is increased by using a plurality of different probes that hybridize to the same nucleic acid, e.g., at a different sequential location. For example, an RNA transcript may contain a hybridization region for a plurality of (e.g., 2, 3, 4, 6, 7, 8, 9, 10, 15, 20, 25, 30, 35, 40, 45, 50, or more) probes. Each probe or a secondary probe that hybridizes to the primary probe may contain a detectable label. This allows the plurality of labels all present on the same RNA to produce a detectable signal.

In some embodiments, the methods described herein includes in situ sequencing or sequence detection. One such process includes temporal multiplexing of barcoded probes, e.g., FISH probes. This method, sometimes referred to as multiplexed error-robust fluorescence in situ hybridization (MERFISH) allows spatial transcriptome profiling of a large number of genes or an entire transcriptome (see, e.g., Moffitt et al. Meth. Enzymol. 572. 1-49, 2016, incorporated herein by reference). In this embodiment, a primary probe or set of primary probes (e.g., 24 primary probes) hybridize to a target nucleic acid (e.g., mRNA) in the sample. Each probe may contain a barcode attached thereto. The barcodes may then be detected by performing a set of barcoding rounds in which the barcoded probe with a fluorescent label emits a signal. Each round of barcoding may be initiated by flowing the desired barcode label from a new fluid source. The labels may be detected using different excitation wavelengths (e.g., 640 nm, 561 nm, or 488 nm) during different barcoding rounds. By stitching together the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the biological sample may be sequence by using a probe that includes a unique gene identifier. The probe may be or contain a nicked circle, which can be ligated, thereby allowing extension and amplification of the target sequence, e.g., by RCA. In some embodiments, the amplification product can then be modified with a chemical moiety that polymerizes in the presence of a polymerization initiator. In some embodiments, an amplified product may be embedded within a polymerized matrix (e.g., a hydrogel), thereby creating a spatially fixed three-dimensional cDNA library of the biological sample.

In some embodiments, the in situ sequencing includes sequencing by ligation. In this embodiment, fluorescently labeled probes with two known bases followed by degenerate or universal bases hybridize to a temple. A ligase immobilizes the complex and the biological sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

In some embodiments, detection of one or more analytes (e.g., protein analytes) can be performed using one or more analyte capture agents. In some embodiment, the systems described herein may comprise one or more analyte capture agents, e.g., an array of oligonucleotides. In some aspects, the array may comprise a bead array. As used herein, an “analyte capture agent” refers to an agent that interacts with an analyte (e.g., an analyte in a biological sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (II)(b)(ix) of WO 2020/176788 and/or Section (II)(b)(viii) U.S. Patent Application Publication No. 2020/0277663.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the biological sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (II)(b)(vii) of WO 2020/176788 and/or U.S. Patent Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligations products that serve as proxies for a template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended using reverse transcription. In some embodiments, the capture probe is extended using one or more DNA polymerases. The extended capture probes include the sequence of the capture probe and the sequence of the spatial barcode of the capture probe.

In some embodiments, extended capture probes are amplified (e.g., in bulk solution or on the array) to yield quantities that are sufficient for downstream analysis, e.g., via DNA sequencing. In some embodiments, extended capture probes (e.g., DNA molecules) act as templates for an amplification reaction (e.g., a polymerase chain reaction).

Additional variants of spatial analysis methods, including in some embodiments, an imaging step, are described in Section (II)(a) of WO 2020/176788 and/or U.S. Patent Application Publication No. 2020/0277663. Analysis of captured analytes (and/or intermediate agents or portions thereof), for example, including sample removal, extension of capture probes, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (II)(g) of WO 2020/176788 and/or U.S. Patent Application Publication No. 2020/0277663. Some quality control measures are described in Section (II)(h) of WO 2020/176788 and/or U.S. Patent Application Publication No. 2020/0277663.

Spatial information can provide information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

Spatial information can provide information of biological importance. For example, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

Typically, for spatial array-based methods, a substrate layer (e.g., as described herein) functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section II)(c) of WO 2020/176788 and/or U.S. Patent Application Publication No. 2020/0277663. Exemplary features and geometric attributes of an array can be found in Sections (II)(d)(i), (II)(d)(iii), and (II)(d)(iv) of WO 2020/176788 and/or U.S. Patent Application Publication No. 2020/0277663.

Generally, analytes and/or intermediate agents (or portions thereof) can be captured when contacting a biological sample with a substrate including capture probes (e.g., a substrate with capture probes embedded, spotted, printed, fabricated on the substrate, or a substrate with features (e.g., beads, wells) comprising capture probes). As used herein, “contact,” “contacted,” and/or “contacting,” a biological sample with a substrate refers to any contact (e.g., direct or indirect) such that capture probes can interact (e.g., bind covalently or non-covalently (e.g., hybridize)) with analytes from the biological sample. Capture can be achieved actively (e.g., using electrophoresis) or passively (e.g., using diffusion). Analyte capture is further described in SectI (II)(e) of WO 2020/176788 and/or U.S. Patent Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a biological sample (e.g., to a cell in a biological sample). In some embodiments, a plurality of molecules (e.g., a plurality of nucleic acid molecules) having a plurality of barcodes (e.g., a plurality of spatial barcodes) are introduced to a biological sample (e.g., to a plurality of cells in a biological sample) for use in spatial analysis. In some embodiments, after attaching and/or introducing a molecule having a barcode to a biological sample, the biological sample can be physically separated (e.g., dissociated) into single cells or cell groups for analysis. Some such methods of spatial analysis are described in Section (III) of WO 2020/176788 and/or U.S. Patent Application Publication No. 2020/0277663.

Switch oligonucleotides (also referred to herein as “switch oligos” or “template switching oligonucleotides”) can be used for template switching. In some cases, template switching can be used to increase the length of a cDNA. In some cases, template switching can be used to append a predefined nucleic acid sequence to the cDNA. In an example of template switching, cDNA can be generated from reverse transcription of a template, e.g., cellular mRNA, where a reverse transcriptase with terminal transferase activity can add additional nucleotides, e.g., polyC, to the cDNA in a template independent manner. Switch oligos can include sequences complementary to the additional nucleotides, e.g., polyG. The additional nucleotides (e.g., polyC) on the cDNA can hybridize to the additional nucleotides (e.g., polyG) on the switch oligo, whereby the switch oligo can be used by the reverse transcriptase as template to further extend the cDNA. Template switching oligonucleotides may include a hybridization region and a template region. The hybridization region can comprise any sequen46rovide46ing hybridizing to the target. In some cases, as previously described, the hybridization region comprises a series of G bases to complement the overhanging C bases at the 3′ end of a cDNA molecule. The series of G bases may comprise 1 G base, 2 G bases, 3 G bases, 4 G bases, 5 G bases or more than 5 G bases. The template sequence can comprise any sequence to be incorporated into the cDNA. In some cases, the template region comprises at least 1 (e.g., at least 2, 3, 4, 5 or more) tag sequences and/or functional sequences. Switch oligos may comprise deoxyribonucleic acids; ribonucleic acids; modified nucleic acids including 2-Aminopurine, 2,6-Diaminopurine (2-Amino-dA), inverted dT, 5-Methyl dC, 2′-deoxyinosine, Super T (5-hydroxybutynl-2′-deoxyuridine), Super G (8-aza-7-deazaguanosine), locked nucleic acids (LNAs), unlocked nucleic acids (UNAs, e.g., UNA-A, UNA-U, UNA-C, UNA-G), Iso-dG, Iso-dC, 2′ Fluoro bases (e.g., Fluoro C, Fluoro U, Fluoro A, and Fluoro G), or any combination.

In some cases, the length of a switch oligo may be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250 nucleotides or longer.

In some cases, the length of a switch oligo may be at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides or longer.

In some cases, the length of a switch oligo may be at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides.

In some embodiments, the macromolecular components (e.g., analytes, e.g., bioanalytes) of individual biological samples (e.g., cells) can be identified or detected with unique identifiers (e.g., barcodes) such that upon characterization of those macromolecular components, such that any given component (e.g., bioanalyte) may be traced to the biological sample (e.g., cell) from which it was obtained. The ability to attribute characteristics to individual biological samples or groups of biological samples is provided by the assignment of unique identifiers specifically to an individual biological sample or groups of biological samples. Unique identifiers, for example, in the form of nucleic acid barcodes, can be assigned or associated with individual biological samples (e.g., cells) or populations of biological samples (e.g., cells), or genes (e.g., mRNA transcripts, in order to tag or label the biological sample's macromolecular components (and as a result, its characteristics) with the unique identifiers. These unique identifiers can then be used to attribute the biological sample's components and characteristics to an individual biological sample or group of biological samples.

In some aspects, the unique identifiers are provided in the form of oligonucleotides that comprise nucleic acid barcode sequences that may be attached to or otherwise associated with the nucleic acid contents of individual biological sample, or to other components of the biological sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) used in the methods described herein can also include other functional sequences useful in processing of nucleic acids from biological samples contained in the droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

The methods described herein m49rovideude providing molecular labels, e.g., via a fluid source. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The systems and methods of the present disclosure may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. US2019/0177800, US2019/0323088, US2019/0338353, and US2020/0002763, each of which is incorporated herein by reference in its entirety).

In an example, a fluid is provided that includes large numbers of the above described barcoded oligonucleotides releasably attached to a label. In some cases, a fluid will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more.

In some cases, it may be desirable to incorporate multiple different barcodes within a given sample. For example, in some cases, mixed, but known barcode sequences set may provide greater assurance of identification in the subsequent processing, for example, by providing a stronger address or attribution of the barcodes to a given droplet, as a duplicate or independent confirmation of the output from a given sample.

Oligonucleotides may be releasable from the labels (e.g., optical label, e.g., fluorescent label) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature will result in cleavage of a linkage or other release of the oligonucleotides from the label. In still other cases, a chemical stimulus is used that cleaves a linkage of the oligonucleotides to the label, or otherwise results in release of the oligonucleotides from the label, e.g., beads.

Methods of System Manufacture

The systems of the present disclosure may be fabricated in any of a variety of conventional ways. These structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

The fluidic interface layer and substrate layers may be made in whole or in part from glass, polymer (e.g., polystyrene, polycarbonate, polyethylene terephthalate, polypropylene, polyethylene, PTFE, COC, PMMA, etc.), ceramic, metal, or a combination thereof. The fluidic interface may be constructed of multiple layers, e.g., a top layer and a bottom layer.

Polymeric system components may be fabricated using any of a number of processes including soft lithography, embossing techniques, micromachining, e.g., laser machining, or in some aspects injection molding of the layer components that include the defined channels as well as other structures, e.g., reservoirs, integrated functional components, etc. In such cases, a laminating layer may be adhered to the molded structured part through readily available methods, including thermal lamination, solvent based lamination, sonic welding, or the like.

As will be appreciated, structures comprised of inorganic materials also may be fabricated using known techniques. For example, structures such as channels or reservoirs may be micro-machined into surfaces or etched into the surfaces using standard photolithographic techniques. In some aspects, the systems or components thereof may be fabricated using three-dimensional printing techniques to fabricate the channel or other structures of the systems and/or their discrete components.

Methods for Surface Modifications

The disclosure features methods for producing a flow system (e.g., a microfluidic device) that has a surface modification, e.g., a surface with a modified water contact angle. The methods may be employed to modify the surface of a system such that a liquid can “wet” the surface by altering the contact angle the liquid makes with the surface.

Systems to be modified with surface coating agents may be primed, e.g., pre-treated, before coating processes occur. In certain embodiments, the first contact angle is greater than the water contact angle of the primed surface. In other embodiments, the first contact angle is greater than the water contact angle of the system component surface. Thus, the method allows for the differential coating of surfaces within or on the system.

A surface may be primed by depositing a metal oxide onto it. Example metal oxides useful for priming surfaces include, but are not limited to, Al₂O₃, TiO₂, SiO₂, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be prepared on a surface by depositing trimethylaluminum (TMA) and water.

In some cases, the coating agent may create a surface that has a water contact angle greater than 90°, e.g., hydrophobic or fluorophilic, or may create a surface with a water contact angle of less than 90°, e.g., hydrophilic. For example, a fluorophilic surface may be created by flowing fluorosilane (e.g., H₃FSi) through a primed system surface, e.g., a surface coated in a metal oxide. The priming of the surfaces of the system enhances the adhesion of the coating agents to the surface by providing appropriate surface functional groups. In some cases, the coating agent used to coat the primed surface may be a liquid reagent.

### EXAMPLES

### Example 1. Dispensing a Reagent from a Blister

FIG. 1A illustrates a perspective view of an exemplary blister pack 100 containing a blister 110 filled with a reagent 120. The blister pack 100 contains a channel 130 that extends from the blister 110 to allow the reagent 120 to be dispensed from the blister 110. The channel contains an outlet 140 through which the reagent can exit the blister pack 100. FIG. 1B illustrates a perspective view of a substrate 150 containing a well 160 and a sample 170 (e.g., a biological sample) disposed in the well. The blister pack 100 may be arranged with the substrate 150 such that the reagent 120 is dispensed from the blister 110 through the outlet 140 of the channel 130 and into the well 160 of substrate 150. The reagent 120 may then coat and/or immerse the sample 170 in the well 160.

As shown in FIG. 2, the blister pack 200 has blister 210 containing a top foil laminate 224 that forms the reagent boundary of the blister with the bottom foil laminate 222. The top foil laminate 224 and bottom foil laminate 222 may be sealed with a seal 270 (e.g., heat seal). The base 230 of the blister 210 has one or more piercing members 240 that can pierce the bottom foil laminate 224 and allow the reagent 250 to be dispensed from the blister 210 through a nozzle 260.

As shown in FIG. 3, the reagent in the blister may be dispensed by breaking a foil laminate 326 that seals an outlet 380 of a nozzle 360. Breaking the foil laminate 326 opens the outlet 380 of nozzle 360, allowing reagent 350 to be dispensed from the blister 310.

As shown in FIG. 4, the blister may be dispensed by breaking a frangible seal (e.g., a kiss cut frangible seal). Blister 410 has a base 430 with a bottom foil laminate 422 and frangible seal 450 (e.g., a kiss cut part way through the bottom foil laminate) inside the blister 410. The top foil laminate 424 of the blister 410 may depress upon actuation, such that the frangible seal 450 breaks and dispenses the reagent 450 housed in the blister 410.

As shown in FIGS. 5A and 5B, the blister may be dispensed by breaking a frangible seal attached to a nozzle. Blister pack 500 has a base 530 and a nozzle 560 with a frangible seal 570 sealing the outlet 580 of nozzle 560. The seal 570 of the outlet 580 of nozzle 560 can be broken (e.g., cut or torn) to open the outlet 580, thereby allowing the reagent 550 to be dispensed from blister 510 and flow therefrom.

### Example 2. Dispensing a Reagent from a Blister Pack Arranged on a Reel

FIG. 6A-6C illustrate an exemplary system with a blister pack 600 with a plurality of reagent-filled blisters 610. Each blister has a base and a top layer and contains a liquid reagent. In various embodiments, the plurality of reagent-filled blisters may include the same reagent (e.g., labelled oligonucleotide probes). In various embodiments, the plurality of reagent-filled blisters may include different reagents (e.g., labelled oligonucleotide probes). In various embodiments, the reagents contained within the linearly connected blisters correspond to cycled reagents for genomic analysis (e.g., in situ analysis). For example, the first fifteen blisters may be filled with reagents for each of fifteen cycles. In another example, the first 60 blisters may be filled with reagents for each of fifteen cycles such that four blisters are dispensed during each cycle. The plurality of blisters 610 is linearly connected and disposed on a first reel 652 that transports each blister 610 adjacent an actuator. The system further includes a second reel 654 configured to receive the plurality of blisters 610 following actuation to collect the emptied blisters 610 of the blister pack 600.

FIG. 7A shows an exemplary system with a blister pack 700 employed with reels. The plurality of blisters 710 is linearly connected and disposed on a first reel 752 that is configured to transport each blister 710 adjacent an actuator 790. The system further includes a second reel 754 that receives the plurality of blisters 710 following actuation to collect the emptied blisters 710 of the blister pack 700. Each blister 710 can dispense a reagent from the blister 710 through the outlet 740 of the channel 730 and into the well 760 of substrate 750 that contains a sample 770 (e.g., a biological sample). FIG. 7B shows the system after the reagent is dispensed. Following actuation, the reagent from each blister 710 is dispensed from the blister 710 through the outlet 740 of the channel 730 and into the well 760 of substrate 750 that contains a sample 770 (e.g., a biological sample).

### Example 3. Blister Pack Integrated with a Substrate

FIG. 8 illustrates a blister pack 800 having a plurality of blisters 810 and being integrated with a substrate 850. Each blister 810 contains a reagent that may be transported along a channel 830 to the substrate 850. A coverslip 890 may be disposed on the substrate 850 to form a flow cell containing a sample chamber 870. The substrate 850 may further include a waste well 880 to receive reagents after they have passed through the sample chamber 870 formed by substrate 850 and coverslip 890.

### Other Embodiments

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

Other embodiments are in the claims.

1. A system comprising:
a blister pack having a blister comprising a base and a top layer, wherein the blister contains a liquid reagent;
an actuator configured to release the liquid reagent from the blister; and
a substrate configured to hold a tissue sample and receive the liquid reagent from the blister upon release.

2. The system of claim 1, wherein the blister comprises a frangible seal.

3. (canceled)

4. The system of claim 1, wherein the blister further comprises an internal layer.

5. The system of claim 4, wherein the blister comprises a piercing member configured to pierce the internal layer and/or the internal layer comprises a frangible seal.

6-8. (canceled)

9. The system of claim 1, wherein the actuator is integral with the blister pack.

10. The system of claim 1, wherein the blister pack further comprises a nozzle configured to dispense the liquid reagent from the blister or a channel configured to transport the liquid reagent from the blister upon actuation.

11. The system of claim 1, wherein the blister pack further comprises a nozzle and the nozzle is sealed.

12. The system of claim 10, wherein the nozzle is configured to pierce the blister.

13. The system of claim 1, wherein the blister pack further comprises a channel configured to transport the liquid reagent from the blister upon actuation.

14. The system of claim 1, wherein the blister pack comprises a plurality of blisters, each comprising a base and a top layer and housing a liquid reagent.

15. The system of claim 14, wherein the plurality of blisters is linearly connected.

16. The system of claim 15, further comprising a reel on which the plurality of blisters is disposed.

17. (canceled)

18. The system of claim 16, further comprising a second reel configured to receive the plurality of blisters following actuation.

19. The system of claim 1, wherein the blister and the substrate are integral.

20. The system of claim 1, further comprising a layer disposed on the substrate to form a flow cell comprising an inlet and an outlet.

21-23. (canceled)

24. A method of dispensing a reagent comprising:
providing the system of claim 1;
actuating the actuator to trigger release of the liquid reagent from the blister, wherein the reagent is dispensed to the substrate.

25. The method of claim 24, wherein the base of the blister or an internal layer comprises a frangible seal, and actuating the actuator breaks the frangible seal by compressing the blister or the blister pack comprises a piercing member, and the actuator pushes the piercing member into the base or an internal layer by compressing the blister.

26. (canceled)

27. The method of claim 24, wherein the blister pack comprises a plurality of blisters, each comprising a base and a top layer and housing a liquid reagent.

28. (canceled)

29. The method of claim 27, wherein the plurality of blisters is linearly connected, system further comprises a reel on which the plurality of blisters is disposed, and the method further comprises transporting each blister adjacent the actuator.

30. (canceled)

31. The method of claim 27, wherein each blister houses one of a plurality of distinct liquid reagents, and the releasing step comprises serially dispensing each distinct liquid reagent to the substrate.
